(19) United States
(12) Patent Application Publication
(10) Pub. No.: US 2026/0179494 A1
(43) Pub. Date: Jun. 25, 2026

(54) SYSTEM AND METHOD FOR THE REGULATION OF AERIAL TRAFFIC AND TRANSPORTATION VIA SKY WAYS

(71) Applicant: Marc Chelnik, Woodstock, NY (US)

(72) Inventor: Marc Chelnik, Woodstock, NY (US)

(21) Appl. No.: 19/318,629

(22) Filed: Sep. 4, 2025

Related U.S. Application Data
(60) Provisional application No. 63/737,210, filed on Dec. 20, 2024.

(51) Int. Cl. G08G 5/34; G08G 5/80

(52) U.S. Cl. CPC G08G 5/34; G08G 5/80

(57) ABSTRACT

A sentinel-mediated system of controlling aerial vehicles or devices that enables coordinated travel of multiple aerial vehicles or devices. The system may include autonomous sentinels configured to monitor, manage, or regulate flight paths. Airborne vehicles and sentinels may form a dynamic infrastructure characterized by real-time traffic control, collision avoidance, and emergency routing. The system may measure and adjust speed and position of its components to enable safe, efficient, and scalable air transportation. The system creates an aerial “SkyWay” or three-dimensional connective system that can be used to coordinate the flow of devices from one point to another. The system solves the problem of traffic control, congestion and safety issues pertaining to navigating an aerial environment. It may integrate with predefined flight paths that are merged into the system to maximize flight flexibility and to create traffic and safety efficiencies. Portions of the system may also be used for non-aerial vehicles.

### TECHNICAL FIELD OF THE DISCLOSURE

The invention of the present disclosure is related to the field of aerial transportation systems and controlled movement of vehicles & objects. More specifically, the present disclosure relates to a system that controls and manages vehicles or other devices within and without designated three-dimensional pathways.

### INTRODUCTION

Recent advances in transportation technology have catalyzed the development of vehicles capable of aerial motion and vehicles capable of operating without continuous human input. With these advances, electric aerial vehicles (AVs), vertical take-off and landing (VTOL) aircraft, and other drone devices have become more readily available.

Currently, autonomous vehicle systems operate in limited, highly controlled environments and lack the infrastructure required for widespread use. These currently known systems are unable to adapt to complex, high-density environments with a variety of other vehicles and obstacles or conditions that may impact the operation of the system. Because traditional air traffic control systems are centralized, optimized for high-altitude, low-density transport, and require continuous human attention, they cannot scale to accommodate a large number of vehicles at relatively low altitudes following innumerable paths across cities or regions. These existing systems typically rely on localized control units that are characterized by human operators and limited lines of communication, and specific flight path requirements.

Therefore, there exists a need for a system of aerial transport that facilitates point-to-point routing with structured corridors, monitors and controls vehicles and devices within the system to coordinate efficient and safe transport, and includes redundant channels of communication between its components. There also exists a need for a system of aerial transport that exerts real-time, or specific time-sampled control over the position of vehicles and/or devices within the system. Simultaneous control of multiple vehicles and/or devices in the system may enable more efficient, safer transportation solutions.

### SUMMARY

The present invention provides a system for controlling the movement of one or more aerial vehicles or devices along defined three-dimensional paths between start and end points. The system may include a plurality of network of distributed control units (“sentinels”) that define flight path boundaries, exchange data with a central and/or a distributed control network, and assist in the regulation of aerial vehicle traffic. Each aerial vehicle is equipped with onboard modules including a communication interface, flight control, sensors, and processors, that may collect, transmit, and/or receive data.

Flight instructions for each vehicle are dynamically generated based on vehicle density, speed, environmental factors, and predicted traffic flow, using technologies such as artificial intelligence, blockchain, and quantum computing. The system also incorporates collision avoidance, zonal control, and auxiliary lanes for emergency or overflow management.

A corresponding method for controlling aerial vehicle traffic includes receiving a flight request, assigning a suitable flight path, and adjusting instructions at predetermined intervals of time or in real-time based on ongoing data collection from various sources.

Each aerial vehicle may be configured to include a processor, a communication module, a flight control module, one or more sensors, and one or more transmitters which may enable communication between the aerial vehicle, the sentinels, other aerial vehicles, and the control network.

The control network may incorporate positioning technology, positional 3D mapping, artificial intelligence, blockchain-based verification, and/or quantum computing framework to provide secure and scalable coordination of aerial vehicles across a variety of complex paths.

### BRIEF DESCRIPTION OF THE DRAWINGS

FIG. 1 is a diagram of an exemplary embodiment of a flight path, showing lanes and sentinels.

FIG. 2 is a diagram illustrating a simplified exemplary embodiment of the system with lanes, a transition zone, and a local control module.

FIG. 3 is a diagram depicting an exemplary three-lane embodiment of a block defined by sentinels, depicting the varied speeds in each of the lanes.

FIG. 4 is a diagram showing an exemplary embodiment of the system, featuring a transition zone, a launch zone, a landing zone, and a central hub.

FIG. 5 is a diagram showing a perspective view of an embodiment of the system with multiple lanes and auxiliary lanes at varied altitudes, a launch zone, landing zone, and a central hub.

FIG. 6 is a diagram showing a cross-sectional perspective view of the system, with multiple lanes positioned at varied altitudes.

FIG. 7 is a system diagram showing an example of the communication pathways that may form the control network in an embodiment with a centralized control network.

FIG. 8 is a schematic of an exemplary process of interactive response information exchange between components of the system, that allows for the retrieval of traffic information and the control of the aerial vehicles in the flight path.

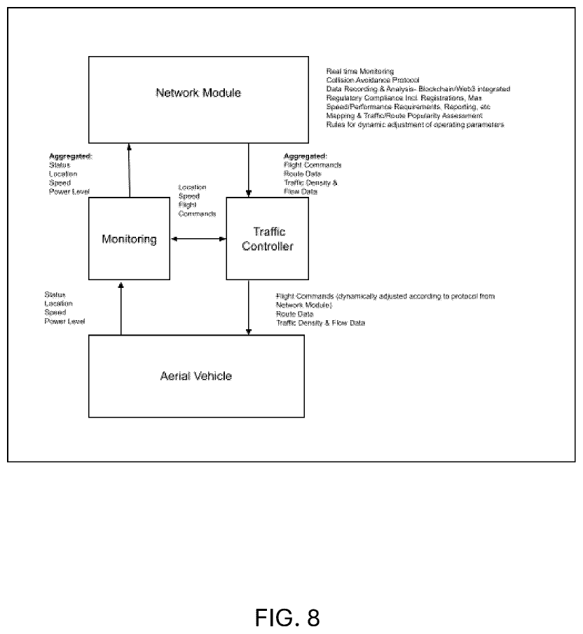

FIG. 9 is a map overlay showing exemplary components of an embodiment of the system in the Washington D.C. metropolitan area, including predefined sky ways, central hubs in major cities, and other hubs to connect major corridors.

FIG. 10 is an illustration of an embodiment of the system in which aerial vehicles can optionally travel outside of sentinel-moderated flight paths to and from a point, within or without a predefined flight path.

### DETAILED DESCRIPTION

Throughout the specification, wherever practicable, like structures, steps, or elements will be identified by like reference numbers. In some figures, components such as electrical connections or fasteners have been omitted for clarity in the drawings. Although the present system and method have been described in terms of various embodiments, it is to be understood that such disclosure is not intended to be limiting. The embodiments are intended to be illustrative, not limiting. Various alterations and modifications will be readily apparent to those of skill in the art. Accordingly, it is intended that the claims be interpreted to cover all alterations and modifications that fall within the spirit and scope of the invention.

Aspects of the present disclosure may be used to provide a system and method of transport and conveyance. The present disclosure may include an aerial “Sky Way” system that enables coordinated movement of flying vehicles in predefined areas (flight paths). In an alternative embodiment, the system of the present disclosure may enable coordinated movement of aerial vehicles between a start point and an end point, and some or none of the aerial vehicle's movement between the start point and the end point may be within predefined areas.

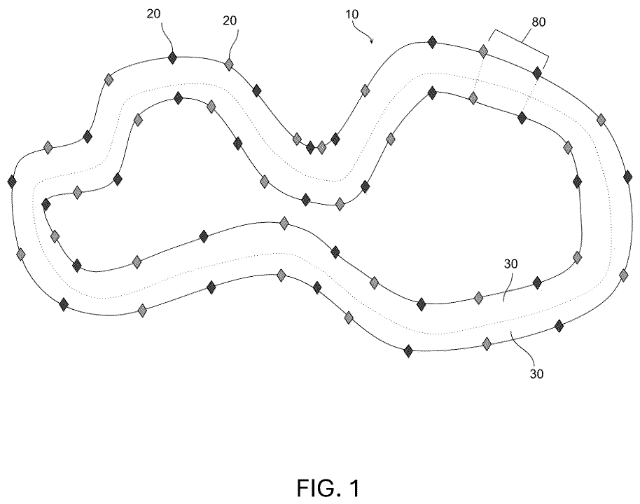

Turning to FIG. 1, the system of the present disclosure may include one or more three-dimensional pathways (flight paths, 10). The perimeters of each of the flight paths may be defined by a plurality of sentinels 20. In one embodiment, each of the plurality of sentinels 20 may be an aerial drone. In an embodiment, each of the plurality of sentinels 20 may be any device suitable to marking a point in space, including but not limited to drones, beacons, virtual coordinate markers, or any other suitable device or apparatus known in the art. Other optional configurations for sentinels 20 are described below. In an embodiment, each of the sentinels 20 may maintain a fixed position, or may dynamically adjust its position according to feedback from other components of the system (discussed in more detail below). In an alternative embodiment, each of the plurality of sentinels 20 may be a transmitter located on the ground, in water, in a satellite, or in any other suitable location. In another alternative embodiment, each of the plurality of sentinels 20 may be a virtual point defined by reference to a set of GPS coordinates or to any other location on the ground.

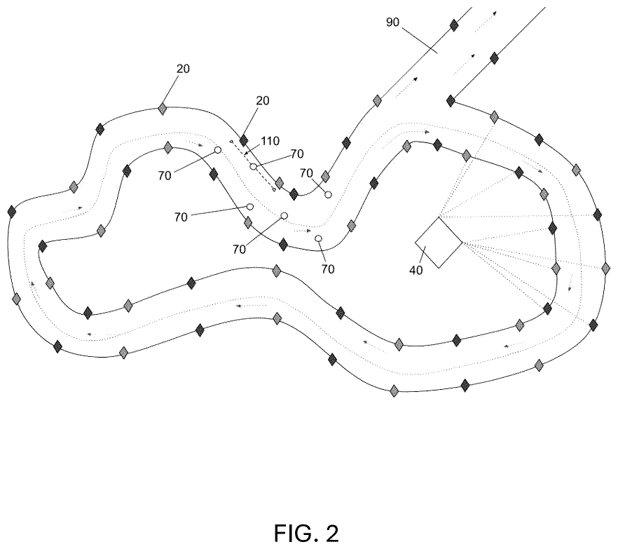

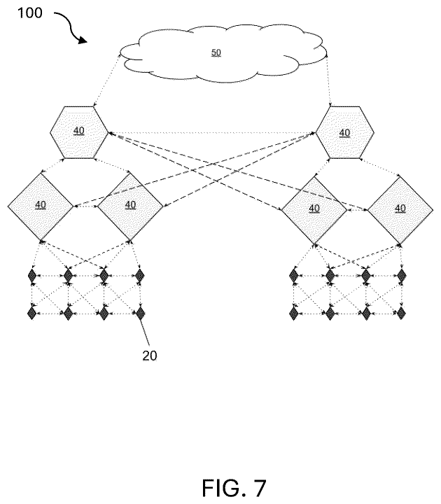

Turning to FIG. 2, in one embodiment, the system of the present disclosure may include one or more aerial vehicles 70. Each of the one or more aerial vehicles 70 may comprise a processor, a communication module, a flight control module, and one or more onboard sensors. The processor may be a microprocessor or system-on-chip (SoC) that handles data processing, navigation, flight control, and communication with other elements of the system. The communication module may send and/or receive information via 5G, Wi-Fi, RF, satellite link, or any other suitable wireless communication protocol known in the art. The communication module may be configured to send and/or receive information including flight data, telemetry data, control instructions, data collected by the one or more sensors, and data received from other aerial vehicles 70, sentinels 20, or to any part of a control network 100 (one example shown in FIG. 7), including a local control module 40. The flight control module may be responsible for controlling the movement of the aerial vehicle, including the execution of control instructions and adjustments to the movement based on sensor data and/or user input. The flight control module may include one or more flight actuators (e.g., propellers, control surfaces) to execute flight instruction updates, and may also rely on PID controllers, simultaneous localization and mapping technology, or sensor fusion techniques for real-time control.

The one or more sensors may each be a thermometer, barometer, accelerometer, gyroscope, global positioning system, compass, optical flow sensor, LiDAR, infrared sensor, stereo vision sensor, humidity sensor, radar, camera, or ultrasonic sensor. The one or more sensors may collect sensor data, which may be sent to the processor and/or the communication module. The processor may be responsible for receiving sensor data, real-time computation of flight dynamics, and local decision making. The sensor data in turn may be transmitted to any part of the control network 100, and may be used to update or modify the flight instructions of each of the aerial vehicles 70. Each of the aerial vehicles 70 may independently, optionally include a mechanism for user input, which may enable a user to control and/or modify the flight of the aerial vehicle. The user input may be a touch screen, one or more buttons, a steering component such as a wheel or joystick, or any other suitable input mechanism known in the art.

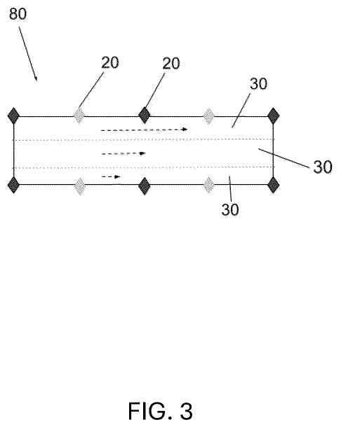

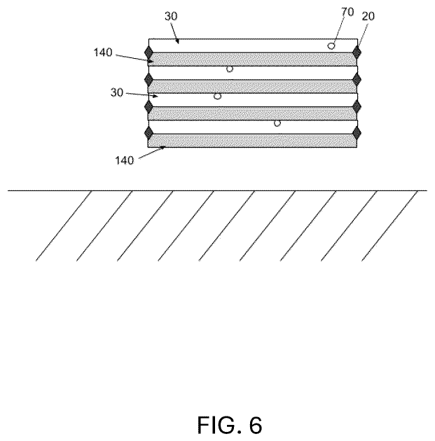

As shown in FIGS. 1-6, flight paths 10 may be three-dimensional spaces within which aerial vehicles 70 can move. Flight paths 10 may be structured in a manner that accounts for multiple layers of altitude or parallel configuration, ensuring that each aerial vehicle 70 follows a designated corridor (a lane, 30). FIG. 6 illustrates an embodiment of the system with lanes 30 stacked on top of one another at different altitudes. In an alternative embodiment, lanes 30 may be positioned next to one another at the same altitude. Additionally, lanes 30 may be offset both horizontally and vertically from one another. Each flight path 10 may have a start point and an end point that may be assigned by a user via an integrated user input, either within an aerial vehicle 70 or another device. Alternatively, the start point and/or the end point may be assigned by a central control 50 to a particular flight path 10 based on a user input or based on a command from the central control 50. In an embodiment, some lanes 30 may be used for regular travel, while other lanes 30 may be reserved for overflow or emergency use.

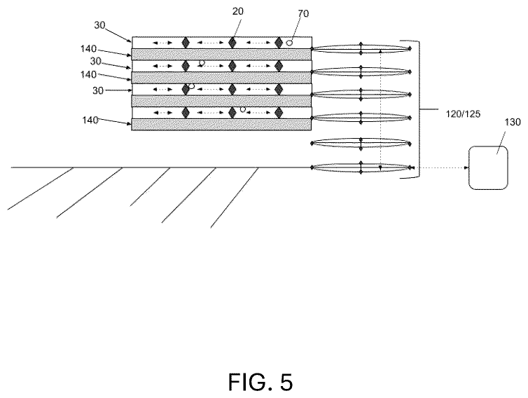

Turning to FIG. 5, Launch zones 120 and landing zones 125 may be three-dimensional airspaces extending between one or more lanes 30 and the ground, or alternatively between one or more lanes 30 and an auxiliary airspace. The launch zones 120 and landing zones 125 may allow organized queuing, ascent, and/or descent of the aerial vehicles 70. Each aerial vehicle 70 may navigate from a ground-level start point to one of the lanes 30 via one or more launch zones 120, and may similarly navigate from a lane 30 to a ground-level end point via one or morelanding zones 125. In an alternative embodiment, the start point and/or the end point may be located in a central hub 130. In such an embodiment, the central hub 130 may be a storage facility designed to collect and house the aerial vehicles 70 while not in use. In one embodiment, the central hub 130 may store aerial vehicles and may release them in the order they entered the central hub 130 upon a request from a user. In an embodiment, the central hub 130 may include a series of “reserved” storage spaces for user-owned aerial vehicles, which may be released upon input from the owner.

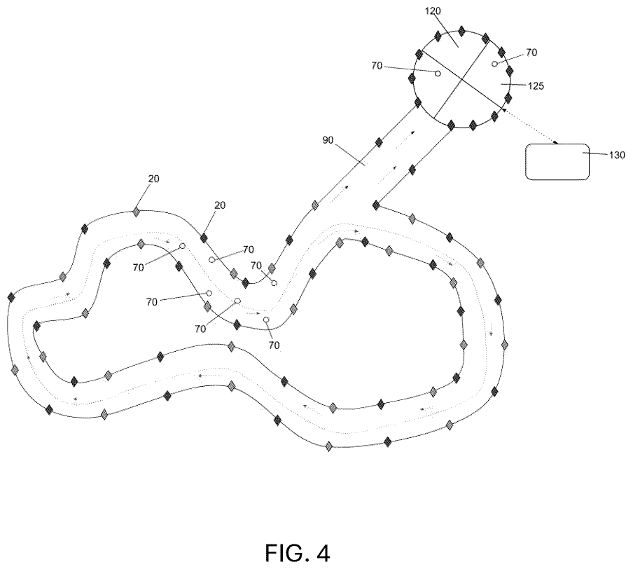

As shown in FIGS. 2 and 4, Flight paths 10 may also be connected to one another by one or more transition zones 90, which may be three-dimensional spaces that serve as buffers between lanes 30, launch zones, landing zones, hubs, and/or flight paths 10. Each of the transition zones 90 may independently be configured to direct aerial vehicle traffic along a substantially straight path, along a curved path, or in an annular path. Transition zones 90 may be useful in managing queuing between high-density flight paths 10; preventing and/or minimizing congestion; and temporarily holding aerial vehicles 70 until they are cleared to enter a particular flight path 10 or lane 30. Additionally, the transition zones 90 between flight paths 10 may be configured to reduce the flight speed of the aerial vehicle(s) 70 while in the transition zone 90.

The flight paths may be defined by a collection of one of more sentinels 20. The sentinels 20 may be aerial drones; virtual geolocation markers; ground-or water-based beacons; manned aerial vehicles, or any other suitable device known in the art. Each of the one or more sentinels 20 may contain one or more transmitters, at least one sensor, and a sentinel processor. The sentinel processor may be capable of autonomous or semi-autonomous operation, and may enable control of one or more aerial vehicles with little to no human monitoring and input. The sentinels 20 may be capable of monitoring the position and movement of aerial vehicle(s), delivering flight instructions, and communicating measured data within and/or without the control network 100.

Each of the sentinels 20 may be positioned based on an algorithm that optimizes traffic flow and minimizes collision risk. As a non-limiting example, each of the sentinels 20 may communicate with one or more of the aerial vehicles 70, other sentinel(s) 20, and/or the control network 100 via radio, wireless, LAN, Bluetooth, satellite, or any suitable protocol. In one embodiment, the sentinels 20 may be arranged in pairs. In such an embodiment, a virtual line extending between each sentinel 20 in a pair of sentinels may form a border dividing the flight path 10 into lengthwise segments (i.e., a “block” 80). These blocks 80 may be arranged in sequence. The density and speed of aerial vehicles 70 within any particular block 80 may be monitored and reported to the control network 100 by the sentinels 20 adjacent to that block 80.

The movement of aerial vehicles 70 within the system may be controlled by a control network 100. The control network 100 may consist of the aerial vehicles, the sentinels, and/or a central control unit. The control network 100 may be a mesh distributed or undistributed network. In an embodiment, the control network 100 may operate via any method of wireless communication known in the art, alone or in combination with any suitable method of wired communication known in the art (i.e., ethernet connections, etc.). The control network 100 may be responsible for determining flight instructions, monitoring aerial vehicle 70 positions en masse, regulating speed, density, and flow of aerial vehicles 70 within the system, and communicating with sentinels 20 and aerial vehicles 70. The control network 100 may include a local control module 40 (e.g., nearby sentinels 20 or computing units) and a central control module 50 (e.g., a cloud or centralized server). Each of the local control modules 40 and the central control modules 50 may operate independently or in coordination with the other. The central control module 50 may oversee global traffic management, long-range routing, and system-level optimizations. This module may reside in a cloud-based server environment and maintain continuous communication with aerial vehicles and sentinels 20 via satellite, internet, or other communication method known in the art.

Local control modules 40 may be located within city or local infrastructure, hubs, or even onboard sentinels 20. Local control modules 40 may continue to manage operations independently in the event of disconnection from the central control module 50.

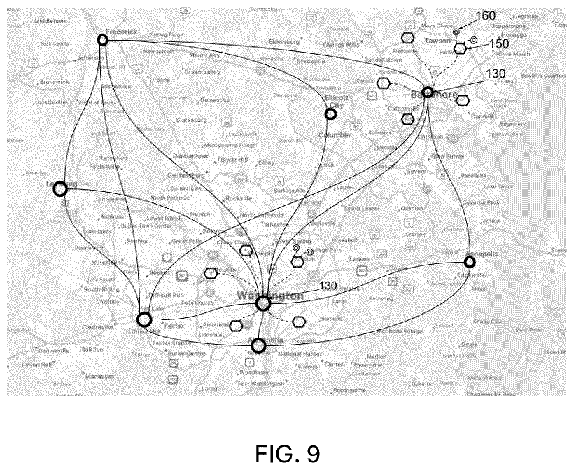

One example of the type of control that may be exercised by the control network 100 is that aerial vehicles 70 may be required to execute a collision avoidance protocol in certain situations. To determine when a collision avoidance protocol is necessary, the control network 100 may calculate a critical distance 110 for a particular aerial vehicle 70 based on the altitude, momentum, and speed of said aerial vehicle 70. The collision avoidance protocol may be initiated when the critical distance 110 exceeds the actual distance between an aerial vehicle 70 and a potential obstacle. The collision avoidance protocol may prompt an aerial vehicle 70 to change lanes, move to an auxiliary lane 140 (i.e., a “drop down zone”), modify its speed, or in some circumstances, make an emergency landing. The collision avoidance protocol may be initiated by any component of the system, including the aerial vehicle(s). The collision avoidance protocol may also be initiated via a manual override or user input. In an embodiment, the lanes may be horizontally offset from one another, vertically offset from one another, or diagonally offset from one another. Further, the lanes may provide for a safety “drop down” zone to remove aerial vehicles 70 from the flow of traffic if necessary. Turning to FIG. 9, the system of the present disclosure may be useful in efficiently navigating urban areas. FIG. 9 illustrates an exemplary embodiment of how the system may work in the metropolitan Washington, D.C. area. In this embodiment, central hub 130 may be located at an epicenter of the city, for example in or near a downtown area. In this exemplary embodiment, a plurality of satellite hubs 150 may be located in relatively less populated or lower traffic areas, compared to the locations of the central hubs 130. Satellite hubs 150 may serve as connection points (a/k/a/ exchanges) between flight paths, and may further connect larger arterial flight paths to more local routes. Also in this embodiment, local hubs 160 may serve to connect lower traffic areas to satellite hubs 150, or directly to central hubs 130. Further, the flight paths may be modified to avoid restricted airspace, to avoid over-water travel, and/or to maximize efficient use. In an embodiment, each of the central hubs 130, the satellite hubs 150, and/or the local hubs 160 may be configured as concentric holding layers that facilitate the redirection of aerial vehicles 70 and the coordination of both the take-off and landing at hub locations.

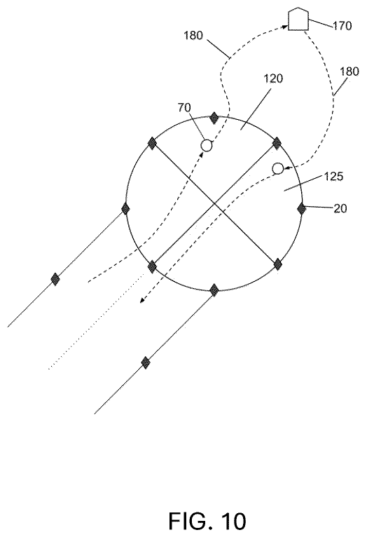

Turning to FIG. 10, the system may also enable movement of aerial vehicles outside of the areas bounded by sentinels 20. In such an embodiment, a user may travel from a start/end point 170 (e.g., their home) to a launch zone 125 via a freeform pathway 180. The freeform pathway 180 may be manually determined or pre-planned by a user, automatically determined or pre-planned by the system, or adjusted in real time by either the user or the system.

The system of the present disclosure may be configured for personal transportation, commercial transportation, freight and logistics deliveries, security operations, and military use—among other purposes. The system may collect real-time data from the aerial vehicles 70 and/or the sentinels, and may use this real-time data to optimize flight commands or otherwise to control the movement of aerial vehicles. For example, if a particular flight path reports elevated density of aerial vehicles, the system may modify the flight instructions sent to one or more of the aerial vehicles as follows. In such circumstances, for example, the system may (1) adjust the position of the sentinels 20 to widen the path and accommodate more traffic, (2) reroute some or all incoming aerial vehicles to a different flight path; or (3) hold incoming aerial vehicles in a transition zone 90 and release them at a controlled frequency into the congested flight path. The system may use real-time flight data to plan future flight instructions and/or to predict traffic flow on any given flight path.

The optimized set of instructions for any particular aerial vehicle 70 or flight path 10 may be the sequence of motion for each of the aerial vehicles 70 that minimizes travel time and/or maximizes individual or collective efficiency, while maintaining safe operating conditions. Safe operating conditions may include conditions calculated to lead to low risk of collision, and may vary depending on environmental factors, aerial vehicle load, specific flight path, or any other factor.

The system of the present disclosure may rely on blockchain technology, artificial intelligence, quantum computing, or any other suitable technology known in the art to carry out the functions described herein. The control network 100 may be capable of exchanging and processing large amounts of data, including vehicle telemetry, sensor data, environmental data and weather updates, and predicted traffic conditions. It may use blockchain technology to record and validate flight data in a secure and decentralized manner. Artificial intelligence and machine learning algorithms may be employed to predict traffic patterns, optimize routing, and detect anomalies or inefficiencies within the system. In certain embodiments, quantum computing techniques may be used to solve complex optimization problems that may arise from optimizing the movement of tens, hundreds, or thousands of aerial vehicles in real time.

In one embodiment, a user may pay a monthly recurring fee to gain access to the system of the present disclosure. In alternative embodiments, users may pay a one-time fee for unlimited access, or may pay based on their usage (analogous to mileage) of the system.

Also within the scope and spirit of this disclosure is the method of controlling aerial vehicle movement within the system. The method may include the steps of: receiving a start point from an aerial vehicle, receiving an end point from a user input or from another source such as an aerial vehicle or a central control 50; determining a set of flight instructions based on the start point, the end point, and the available capacity of a plurality of flight paths 10; wherein the plurality of flight paths are three-dimensional spaces defined between a plurality of sentinels 20; and wherein the plurality of sentinels 20 is configured to limit the movement of an aerial vehicle 70 outside of the flight path; executing the flight instructions; collecting flight data while executing the flight instructions via one or more sensors; and adjusting the flight instructions in response to the flight data.

It will be apparent to one of ordinary skill in the art that most if not all inventions disclosed herein may be applied to non-aerial modes of transportation. The 3D airspace within which aerial vehicles fly could be substituted for a 3D aquatic environment through which submarine vehicles could transit. Likewise, any 2D surface to be transited (i.e. the surface of the earth or another planet) is simply a simplified layer or “slice” of the 3D capable systems and methods described herein. Thus, the disclosures described herein with respect to “aerial” transportation should not be considered limited in that respect, but rather simply as examples of a 3D or 2D transportation system that could encompass aircraft, watercraft, land vehicles, trains, trucks, or intermodal vehicles and transportation systems.

It is contemplated that other embodiments of the system and method disclosed herein may be suitable for the functions described in this disclosure. The examples and embodiments described in this disclosure are not to be construed in a limiting sense, and are merely illustrative examples of the possible uses, functions, and components of this disclosure.

What is claimed is:

1. A system for controlling flight of aerial vehicles, comprising:
one or more aerial vehicles; wherein
each of the aerial vehicles contains a communication module, a flight control module, at least one sensor, at least one transmitter, and a processor;
at least one start point and at least one end point;
a plurality of three-dimensional flight paths between a start point and an end point;
a control network,
wherein the control network is configured to determine at least one set of flight instructions for the one or more aerial vehicles.

2. The system of claim 1, wherein at least a portion of each of the flight paths is defined by an outer boundary; and wherein the outer boundary comprises a plurality of sentinels;
wherein each of the sentinels marks a point, and an imaginary line connecting one sentinel to at least one other sentinel forms a boundary and
wherein each of the sentinels communicates either with the aerial vehicles or with a control system, to control movement of the aerial vehicles within the one or more flight paths;
wherein each of the sentinels exchanges information with the control network and or the plurality of sentinels;
wherein each of the sentinels is independently positioned according to an algorithm that is configured to optimize the movement of the aerial vehicles;
wherein each of the sentinels is independently selected from the group comprising drones, virtual positioning markers, satellite defined markers, geopositioning defined markers, ground-based markers, and water-based markers, and manned or unmanned aerial vehicles; and
wherein the control network utilizes radio, wireless communication, local area network, Bluetooth, satellite, or any suitable technology to exchange information.

3. The system of claim 2, wherein the control network is configured to process data from the aerial vehicles, the sentinels, or both, and to optimize the movement of the aerial vehicles within the flight paths.

4. The system of claim 2, wherein the control network is configured to calculate a critical distance based on the data from the aerial vehicles, the sentinels, or both; and wherein the control network is configured to execute a course correction, and optionally execute a collision avoidance protocol when the distance between the aerial vehicle and an obstacle is less than the critical distance.

5. The system of claim 1, wherein the system can be configured to suit personal transportation, commercial transportation, multi-passenger transportation, freight, security, and military purposes.

6. The system of claim 2;
wherein each of the flight paths is divided into at least two zones, each zone separated from the other by a virtual boundary that extends between two sentinels and across a flight path;
wherein each of the zones records the position of the one or more aerial vehicles when said aerial vehicles are within said zone;
wherein the speed and position of an aerial vehicle is regulated within each zone;
wherein the speed and position of aerial vehicles within the zone are monitored and controlled by the control network, the control network using a control algorithm, blockchain technology, artificial intelligence, or quantum computing.

7. The system of claim 1, wherein each of the flight paths comprises a travel corridor and optionally, one or more auxiliary lanes,
wherein the auxiliary lane can be configured to accommodate increased traffic of aerial vehicles or to provide a safety lane,
wherein the travel corridor comprises one or more main lanes configured to accommodate the aerial vehicles,
and wherein the auxiliary lanes can be reserved for emergency use.

8. The system of claim 2, wherein the control network is configured to collect information from the flight paths and to adjust the flight instructions in response to said information,
wherein said information is selected from the group comprising: measured aerial vehicle density, aerial vehicle speed, environmental data, anticipated aerial vehicle density, and flight path capacity; and
wherein the control network comprises a local control module and a central control module, and wherein each of the local control module and the central control module optionally receives, sends, and processes information independent of the other.

9. The system of claim 1, wherein the control network is a coordinated network that enables communication between the sentinels, between the aerial vehicles, between the sentinels and the central control, between the aerial vehicles and the central control, and between the sentinels and the aerial vehicles; and
wherein the movement of one of the aerial vehicles is modified in response to input selected from the group comprising: flight instructions generated by one of the aerial vehicles, flight instructions generated by one of the sentinels, and flight instructions generated by the central control,
wherein the flight instructions generated by the central control are dynamically adjusted in response to feedback from the aerial vehicles, the sentinels, or both.

10. The system of claim 2, wherein each of the sensors is independently selected from the group comprising a thermometer, altimeter, speedometer, vehicle detection sensor, light sensor, motion sensor, barometer, accelerometer, gyroscope, global positioning system, compass, optical flow sensor, LiDAR, infrared sensor, stereo vision sensor, humidity sensor, radar, camera, and ultrasonic sensor.

11. A method for controlling the flight of an aerial vehicle, performed by a control system, the method comprising:
receiving a start point from an aerial vehicle,
receiving an end point from a user input;
determining a set of flight instructions based on the start point, the end point, and the available capacity of a plurality of flight paths;
wherein the plurality of flight paths are three-dimensional spaces defined between a plurality of sentinels; and
executing the flight instructions;
collecting flight data while executing the flight instructions via one or more sensors; and
adjusting the flight instructions in response to the flight data.

12. The method of claim 11, wherein the control system comprises a processor, a memory, a communication module, and a database; and wherein said control system is configured to transmit and receive information including environmental data, aerial vehicle position data, and flight data.

13. The method of claim 11, wherein the control system further comprises a coordinated network configured to enable communication between the sentinels the one or more aerial vehicles, and a central control, wherein each of the sentinels is independently selected from the group comprising: drones, virtual position markers, land or water based markers, and wherein the sentinels are optionally configured to divide a flight path into a plurality of zones and to control the movement of aerial vehicles within said zones.

14. The method of claim 13, wherein adjusting the flight instructions further comprises:
determining a velocity of the aerial vehicle,
wherein the velocity of the aerial vehicle is determined by measuring the position of the aerial vehicle over time with the one or more sensors; and
wherein the sentinels are configured to exchange information with the plurality of aerial vehicles, including a measured velocity and position of the aerial vehicle and the flight instructions,
executing a collision avoidance protocol when the distance between an aerial vehicle and an obstacle falls below a critical distance, wherein the collision avoidance protocol causes the aerial vehicle to move from a travel zone within a flight path to an auxiliary lane within the flight path; and
determining a current efficiency score,
wherein the current efficiency score is based on the difference between an optimal traffic flow rate and a measured traffic flow rate; and
sending updated flight instructions that correspond to a relatively higher efficiency score compared to the current efficiency score.

15. The method of claim 14, wherein the collision avoidance protocol can be initiated by any component of the control system independent of another component.

16. The method of claim 11, wherein executing the flight instructions includes launching the aerial vehicle from the start point, navigating the aerial vehicle to a flight path, moving the aerial vehicle along at least one flight path, and landing the aerial vehicle at the end point;
wherein launching the aerial vehicle from the starting point further comprises:
moving the aerial vehicle from the start point to a launch zone;
wherein the launch zone is comprised of a plurality of three-dimensional layers at different elevations, and each of the layers is configured for the coordinated queuing of one or more aerial vehicles according to a flight protocol;
wherein the start point is located on the ground;
landing the aerial vehicle comprises:
moving the aerial vehicle from a flight path to an end point via a landing zone;
wherein the landing zone is a three-dimensional space comprised of one or more layers to allow for the organized descent of one or more aerial vehicles;
and wherein the end point is located on the ground.

17. The method of claim 11, wherein a first flight path is coupled to a second flight path via a transition zone,
wherein the transition zone is configured to accommodate a queue of aerial vehicles
and to limit the rate of aerial vehicles entering any flight path.

18. The method of claim 11, wherein the method associates a user registration, a subscription identifier, one of the aerial vehicles, and a set of flight instructions with a unique user identification number and records said user, aerial vehicles, and flight instructions in a memory.

19. A method for coordinating movement of a plurality of devices by measuring the position and speed of the devices within adjacent contiguous areas, wherein the devices may be aerial devices, water surface or submarine devices, or land based devices, the method including the steps of:
collecting information from the devices;
wherein the information comprises a speed, a position, and a time stamp,
communicating the information to a control network,
calculating, via the control network, an optimized set of movement instructions for the plurality of devices based on the information collected from the devices; and
executing the optimized set of movement instructions.

20. The method of claim 19, wherein the control system comprises a plurality of blocks that are defined by a plurality of sentinels, wherein the blocks communicate with the aerial vehicles, other sentinels, and the control network; and
wherein the sentinels in coordination define the blocks in a sequence of blocks to obtain data and issue instructions.

21. The method of claim 19, wherein the step of calculating an optimized set of instructions further comprises the steps of exchanging information between a first zone and a second zone, wherein the first zone and the second zone are in proximity to one another, utilizing the information from the second zones to calculate the optimized set of instructions;
wherein the optimized set of instructions is configured to maximize the efficiency of the device movement in response to information collected with one or more sensors.

22. The method of claim 19, further comprising the step of collecting information related to device position with one or more, virtual position sensors, geopositioning sensors, fixed position sensors, satellite, local area network, radio sensors, motion sensors, light detectors, thermometer, altimeter, speedometer, vehicle detection sensor, barometer, accelerometer, gyroscope, global positioning system, compass, optical flow sensor, LiDAR, infrared sensor, stereo vision sensor, humidity sensor, camera, or ultrasonic sensoror radar, each of which may independently be in communication with the control network.

23. The method of claim 19, wherein the step of calculating an optimized set of instructions further comprises using one or more techniques independently selected from the group comprising: central database control, position determination systems, block chain technology, and artificial intelligence, machine learning, and quantum computing, wherein the step is designed to promote efficient movement of the devices.

24. The method of claim 19, further including the steps of adjusting the speed of the devices, adjusting the position of the devices, and minimizing delays in movement which may be caused by collisions, increased local density of obstacles or devices, or interference from external forces, via one or more algorithms.
